(19) United States
(12) Patent Application Publication
(10) Pub. No.: US 2017/0038156 A1
(43) Pub. Date: Feb. 9, 2017

(54) INDUCTION MOLTEN SALT HEAT TRANSFER SYSTEM

(71) Applicant: AJAX TOCCO MAGNETHERMIC CORPORATION, Warren, OH (US)

(72) Inventor: Anthony M. Tenzek, Hanoverton, OH (US)

(73) Assignee: AJAX TOCCO MAGNETHERMIC CORPORATION, Warren, OH (US)

(21) Appl. No.: 15/177,474

(22) Filed: Jun. 9, 2016

Related U.S. Application Data
(60) Provisional application No. 62/201,302, filed on Aug. 5, 2015.

(51) Int. Cl. F28D 20/00; H05B 6/10

(52) U.S. Cl. CPC F28D 20/0034; H05B 6/108; F28D 2020/0047

(57) ABSTRACT

Heat transfer systems and methods are provided. In one example, a heat exchanger apparatus includes: an enclosure defining an interior; an induction coil within the interior; and a plurality of conductive tubes within the induction coil for heating a salt material in the plurality of conductive tubes using a current induced by the induction coil.

### REFERENCE TO RELATED APPLICATION

This application claims priority to, and the benefit of, U.S. Provisional Patent Application Ser. No. 62/201,302, filed on Aug. 5, 2015, entitled INDUCTION MOLTEN SALT HEAT TRANSFER SYSTEM, the entirety of which application is hereby incorporated by reference.

### BACKGROUND

The following relates to heat transfer systems and methods.

### SUMMARY

Various aspects of the present disclosure are now summarized to facilitate a basic understanding of the disclosure, wherein this summary is not an extensive overview of the disclosure, and is intended neither to identify certain elements of the disclosure, nor to delineate the scope thereof. Rather, the primary purpose of this summary is to present various concepts of the disclosure in a simplified form prior to the more detailed description that is presented hereinafter. The present disclosure provides heat transfer systems and methods.

Disclosed examples include a heat transfer system including a plurality of power supplies, each power supply of the plurality of power supplies configured to power a heat exchanger of a plurality of heat exchangers. The system further includes transfer pipes connecting the plurality of heat exchangers. Each heat exchanger of the plurality of heat exchangers includes an enclosure defining an interior; an induction coil within the interior; and a plurality of electrically conductive tubes within the induction coil for heating a molten salt material in the plurality of conductive tubes using a current induced by the induction coil.

### BRIEF DESCRIPTION OF THE DRAWINGS

FIGS. 1A-1B are a schematic diagrams illustrating energy storage systems.

FIG. 2 is a schematic diagram illustrating a heat transfer system.

FIG. 3 illustrates an exemplary heat exchanger.

FIG. 4A illustrates a coil with no internal load (e.g. with no tubes).

FIG. 4B illustrates a coil with one internal load (e.g. with one tube).

FIG. 4C illustrates a coil with multiple internal loads (e.g. with multiple tubes).

FIG. 4D shows an illustration of over heating of a tube exterior due to power supply frequency to high relative to wall thickness.

FIG. 4E shows an illustration of when a depth of current penetration is equal to or slightly greater than a tube wall thickness.

FIG. 5 illustrates heating a salt material.

FIG. 6 illustrates heating a salt material.

### DETAILED DESCRIPTION

Referring now in more detail to the figures, several embodiments or implementations are hereinafter described in conjunction with the drawings, wherein like reference numerals are used to refer to like elements throughout, and wherein the various features are not necessarily drawn to scale. The present disclosure provides systems and methods for heat transfer and heat storage. These aspects of the disclosure find utility in association with using electricity to heat salt. In addition, although illustrated in particular contexts, the disclosed concepts can be employed in any setting where heat transfer and heat storage systems are used.

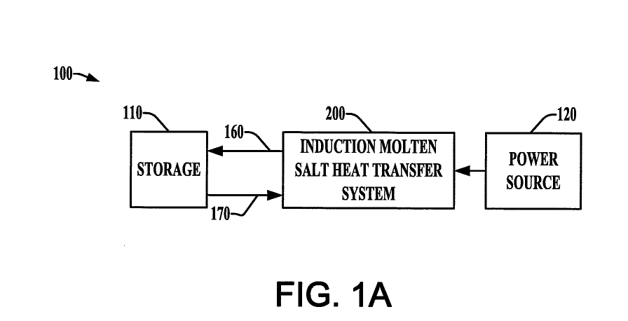

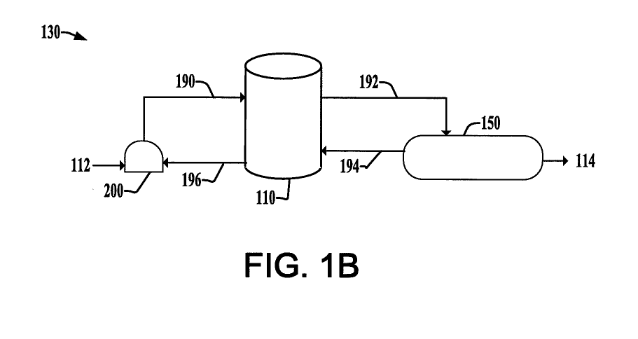

FIG. 1A shows an energy storage system 100 including a storage tank or other storage apparatus 110 for storing molten salt at various temperatures. Typically, a higher temperature is sufficient to allow the transfer of thermal energy to a conversion device for the production of electrical energy resulting in molten salt but at a lower temperature. FIG. 1A further shows an induction molten salt heat transfer system 200 operated by a power source 120.

FIG. 1B shows an energy storage system 130. With reference thereto, the systems and methods described herein allow electrical energy to be taken off the grid (e.g. “off peak” electricity 112) and converted into thermal energy storable in molten salt. This may be done by connecting solid state power supplies to the grid and then converting the current to a higher frequency which then flows through induction coils. This produces an induction field which couples into an array of SST tubes heating them to temperature. Molten salt that is flowing through the tubes absorbs the heat and then flows to the storage tank 110 as hot salt 190. From there, the molten salt then flows to the electric generating plant 150 (as hot salt 192), then back to the storage tank 110 (as warm salt 194), and then back to the salt heat transfer system 200 (as warm salt 196) to be reheated.

The system 100, 130 stores energy in one example during off-peak demand time periods for subsequent recovery during peak demand time periods (e.g. as “on peak” electricity 114). In one possible application, this can be used in an overall system with further components to receive power from an electric power grid (not shown) via the power source 120 in FIG. 1A and use the received power to heat salt by induction heating in the system 200. The storage apparatus 110 stores the heated salt 160, which can then be used (e.g., during peak demand time periods) via a heat exchange power generation apparatus (not shown) to generate electric power for provision to the power grid, with the cold salt 170 being returned to the storage apparatus 110.

Such systems may be quite large (e.g. 100 megawatts). Such systems may also comprise multiple smaller systems such as 5, 10, 20, 30 megawatt systems as required for the application. As a result, the required number of induction power supplies may vary from several down to one.

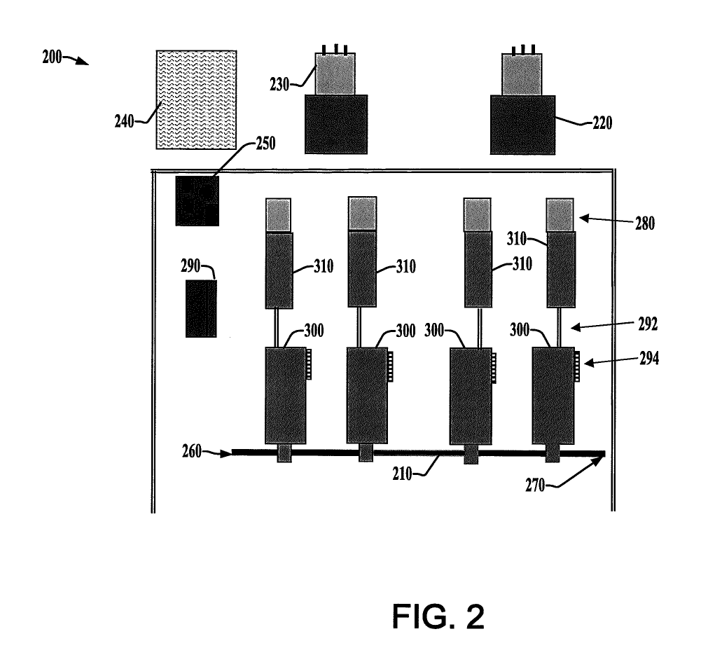

FIG. 2 shows further details of one example induction molten salt heat transfer system 200 which can be used in the systems 100 or 130. With reference thereto, the heat exchangers are shown as vertical. The advantage of placing the heat exchangers vertically is that in case of an emergency the molten salt can be drained from each reactor into the customer storage device or drained into ingots and allowed to cool and re-melted later. As can be seen, there can be as many reactors as necessary in series or a series parallel combination to obtain the desired megawatt rating and desired flow and pressure drop as required to control the design and effectiveness of the heat exchanger(s) with each reactor raising the salt temperature a specific delta T.

The use of the induction molten salt heat transfer system 200 presents a significant advance over different forms of salt heat transfer systems. In particular, other systems employ immersion resistance heaters for heating molten salt, but these suffer from severe corrosion. By using induction heating in the system 200, non-contacting heat exchange is achieved to avoid these problems.

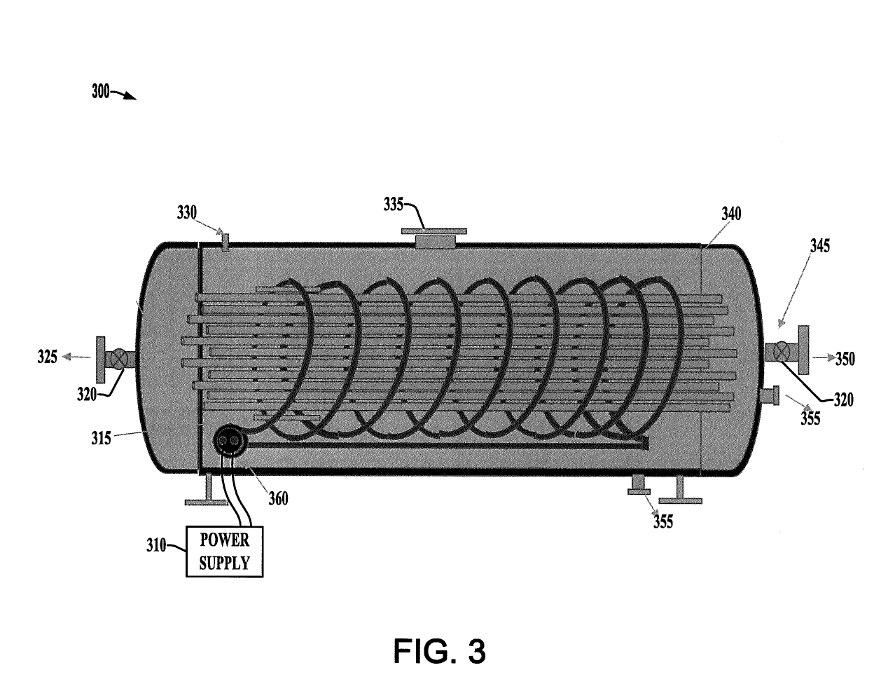

As shown in FIG. 2, the heat transfer system 200 includes a water cooling system to cool and recirculate water as required through the water cooled components of the system for example the power supply and induction coil. Particularly, the heat transfer system 200 includes a water tower 240, and one or more outdoor vacuum breakers 230 as well as transformers 220 (e.g., 15 kV primary transformers in one example), where the power from the input transformers is used to operate power supplies 310 used for powering a set of vertically or horizontally disposed heat exchangers or induction molten salt heat exchanger 300. The heat exchangers 300 include water flow racks 294 and water-cooled induction coils disposed within a tank or container as seen in FIG. 3. In some embodiments, the enclosure in FIG. 3 is a dual-wall water-cooled chamber, and the system 200 and FIG. 2 includes a dual water pump and control station as well as an OP panel 290.

The water pump and control station 250 controls circulation of water from the water tower 240 to the induction coils of the individual heat exchangers 300, and provides for cooling water circulation in a double wall water-cooled chamber, where used.

The system 200 includes a 6 inch inlet 260 and a 6 inch outlet 270 for transfer of molten salt for the heat exchange process. The salt is transferred through a system of insulated and heated transfer pipes 210 from the inlet 260 to the outlet 270. Electrical power is provided to operate the power supplies 310 via indoor vacuum breakers 280 from the secondaries of the outdoor transformers in one example, and various bus wires and leads 292 interconnect the power supplies 310 with the heat exchangers 300. FIG. 2 also shows dual water Pump and control station 250.

FIG. 3 shows an example horizontal heat exchanger 300 that can be used in the induction molten salt heat transfer system 200 of FIG. 2. By applying an alternating current to induction coil 340 an electromagnetic field is produced, which induces a current in the conductive tubes.

With reference to FIG. 3, one embodiment of an individual heat exchanger 300 includes a 10 foot long, 30-40 inch inner diameter induction heating coil 340 defining an interior region through which an array of pipes or tubes that transport the molten salt material for induction heating. In one example, the individual tubes are 2″-3.5″ stainless steel tubes supported by suitable (and electrically non conductive materials so as to not electrically short one tube to another) mounting fixtures (not shown) to be in a spaced relationship with respect to one another, wherein 300 series stainless steel or nickel-based materials can be used in various embodiments, although this is not a strict limitation. In certain implementations, the tubes are preferably made from a nonmagnetic material in order to facilitate efficient heat transfer. The tubes may include an inner tube bundle of Inconel or stainless tubes of the appropriate ID, length and wall thickness to obtain the velocity and turbulence to maximize heat transfer.

The heat exchanger 300 may include an outer double walled stainless steel vessel to contain the induction coil 340.

The induction coil 340 is preferably a hollowed structure with coolant fluid such as water being circulated through the induction coil, e.g., from the dual water pump and control station of FIG. 2. In the illustrated example, the induction coil heats each tube independently due to the action of the uniform electric field within the cross section of the induction coil. The individual tubes are heated and impart thermal transfer to the molten salt flowing inside the tubes in a generally uniform or equal fashion, and the heat exchanger includes series/parallel connections (not shown) at the ends of the tubes in order to provide a configuration of series and/or parallel interconnection to transfer the molten material through the induction heating coil two or more times. Thus, the conductive tubes within each heat exchanger may be connected entirely in series, entirely in parallel, or by any combination of series and parallel connections.

The heat exchanger 300 may also include appropriate non-conductive spacers to assure straightness and linearity of the individual tube bundle members.

The bell ends are designed to affect proper flow (e.g. designed with the correct number of passes). Thus, these ends are extended slightly beyond the power coil ends.

In certain implementations, the tubes form a bundle designed in a series/parallel combination to maximize heat transfer to a specified flow rate while keeping pressure drop within reasonable limits for system design and other elements of the energy storage system pump design and safety reasons. The Example of FIG. 3 shows a heat exchanger disposed generally horizontally. In other embodiments, the heat exchanger chamber may be disposed vertically, or at an angle to facilitate drainage in the event of a leak from one of the tubes, such that preferably molten material can be drained prior to solidifying at the bottom of the chamber. In the example of FIG. 2, moreover, inert gas inlet porting is provided for connection to an argon, or nitrogen or other inert gas source to pressurize the vessel to a level slightly greater than the internal pressure of the tube(s) so the molten salt will not leak out even if a tube ruptures. Moreover, thermal or other sensors 345 may be disposed at the bottom of the interior of the vessel in order to detect leakage of any molten salt material from the tube array, which can be used by a system controller (PLC, etc.) to initiate one or more remedial actions, including bypassing the leaking heat exchanger vessel via inlet and outlet isolation and bypass valves 320. This facilitates timely drainage of still molten material from a leaking vessel, while that vessel is bypassed to allow other series and/or parallel connected vessels to continue operation of the overall system 200.

FIG. 3 also shows: inlet 325, inert gas inlet port 330, transducers 345, drain 355, and power port 360. The power port 360 may be connected to the power supply 310 by a transmission line. The transducers 345 may be at both the inlet 325 and outlet 350, and may be, for example, pressure, flow and/or temperature transducers. The drain 355 may be placed in a different position depending on whether the heat exchanger is placed vertically or horizontally. The drain may also be an over pressure port.

In one example, four such heat exchangers 300 are connected in series as shown in FIG. 2, with each successive heat exchanger 300 elevated in the temperature of the salt material to achieve any desired overall system throughput temperature increase (Δ T). In various implementations, any suitable configuration of two or more such reactors or heat exchanger vessels 300 can be interconnected in any suitable series and/or parallel fashion for a given system design, with the individual heat exchangers 300 being provisioned with inlet and outlet valves for maintenance and/or bypass operations. In one example, moreover, the vessel or chamber itself has end structures that can be removed from the central portion of the vessel by which the induction coil and/or array of tubes can be installed, removed and/or maintained. The vessel or chamber also includes a power port 360 allowing connection to an inverter or other AC electric supply 310. In one example, the power supply 310 operates to provide AC excitation power to energize the induction coil at 300-500 Hz, although any suitable excitation frequency can be used for a given design. In this example, the individual power supplies are capable of providing up to 5000 kW of power at 300-500 Hz, although any suitable level of applied power can be used for a given application. The power level and the frequency can be selected for a given application and system to achieve a desired heat exchange rating, and to achieve a suitable depth of current penetration into the specified wall thickness of the tubes.

Embodiments described herein allow for heating multiple tubes at the same time each having the same heating effect because the field is uniform throughout the coil ID, thus enabling all the tubes to heat the salt uniformly at the same time.

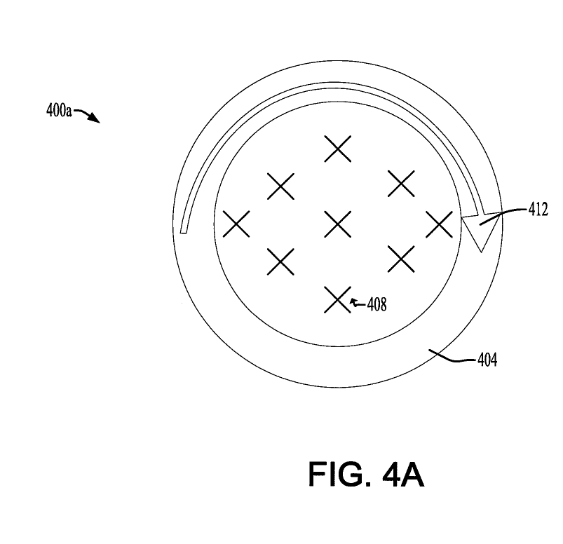

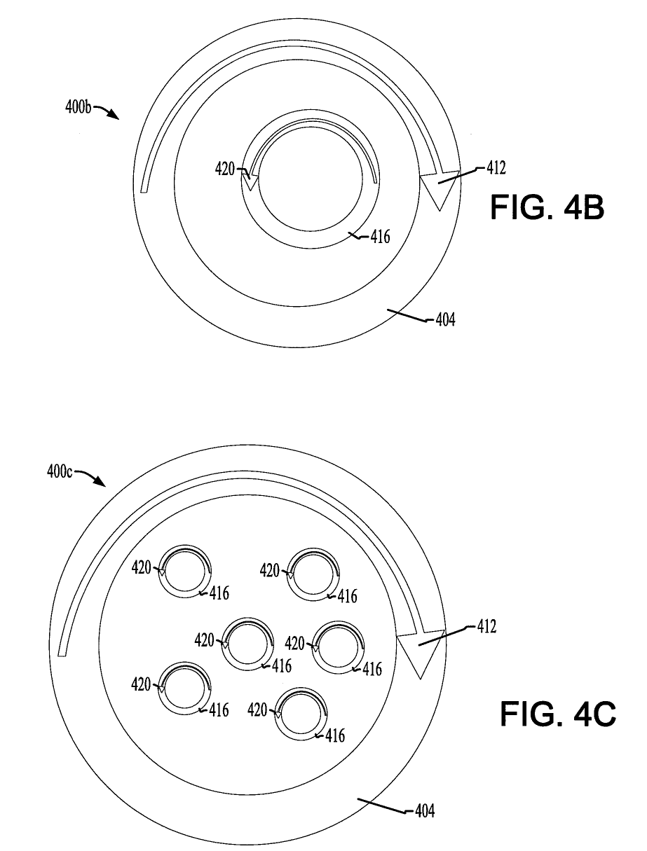

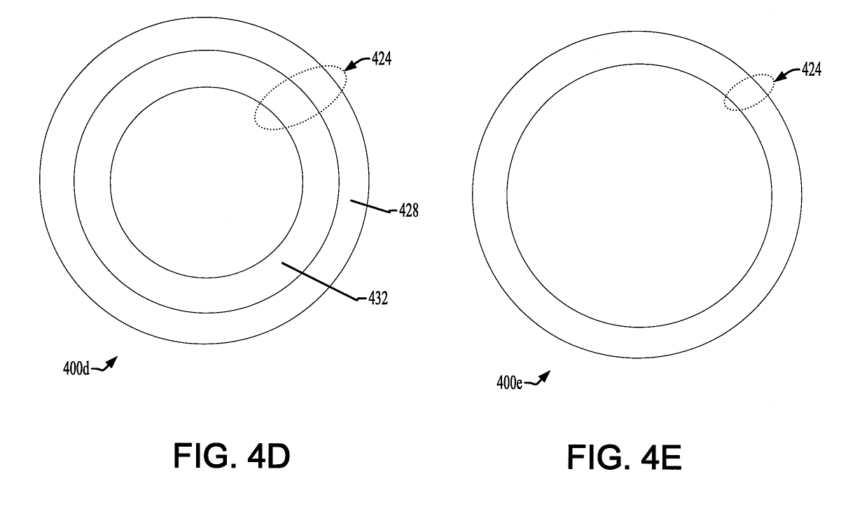

FIG. 4A illustrates an example of a cross sectional view 400a of a coil 404 with no internal load (e.g. with no tubes). In this example, the lines of flux are represented by the Xs 408, and are distributed equally across the diameter. Additionally, the coil current 412 flows circumferentially, as shown by the arrow.

FIG. 4B illustrates the situation of when a load 416 is introduced into a center portion of coil 404, shown as cross sectional view 400b. In the example shown in FIG. 4B, the electric field couples to the single load 416, thereby producing a load current 420 of equal magnitude but in the opposite direction as the coil current 412.

FIG. 4C illustrates a cross sectional view 400c of a coil 404 with multiple internal, identical loads 416. In this example, the electric field couples to the multiple loads 416, thereby producing identical load currents 420 in each tube 416 that are in an opposite direction to the coil current 412. In this example, the sum of all the individual tube currents 420 is equal to the coil current 412. The result of having multiple tubes uniformly coupled to a single coil is that the surface area available to transfer heat of the molten salt is increased. This allows for maximization of the surface area available to transfer heat to the molten salt, allowing for better heat transfer. This also allows for increased efficiency and reduced costs. In addition, smaller diameter tubes allow for increased velocity of the molten salt; this in turn increases the Reynolds number and thus the convection coefficient. This accordingly increases the turbulence and reduces the time required to uniformly heat the molten salt. The embodiment described above is particularly advantageous because of the reduced time required to uniformly heat the molten salt.

The heat exchangers 300 can also individually include one or more sensors for humidity/moisture, temperature, etc., with the vessel including a port 335 for wiring to such internal sensors. In one example, the vessel itself is a dual-wall structure with coolant fluid flowing between the walls. In addition, in order to mitigate heating of the vessel structure itself by operation of the internal induction coil, the vessel may be fashion from carbon steel or other suitable material, with one or more iron laminations or other magnetic shunt structures along the inner diameter of the chamber wall to provide a low reluctance between the induction coil and the vessel wall to combat induced current flow and thus inductive heating in the vessel itself.

As shown by FIG. 3, moreover, an alumina silica or other suitable coil insulating structure 315 is provided between the induction coil and the array of tubes, where any suitable insulating material can be used including without limitation Fiberfrax material. In one example, the coil insulating structure 315 provides thermal insulation and can be configured as a generally cylindrical sleeve extending around the array of tubes within the inner diameter of the induction coil.

In operation, the induction coil 340 is energized by the associated power supply 310 for the individual heat exchangers 300, which convert the input (e.g., line) frequency power to a higher frequency (e.g., 300-500 Hz in one example). The high frequency current flows through the induction coils 340 of the individual heat exchangers 300 to produce an induction field within the interior of the individual induction coils. The presence of the conductive material of the array tubes within this field induces current flow within the tube material, thereby heating the transported salt material through conduction and/or convection. The molten salt flowing through the tubes absorbs the heat multiple times during transport back and forth within each of the individual heat exchangers 300, and the salt picks up and overall additional thermal energy level to transportation through two or more series-connected heat exchangers to reach a final temperature before flowing to the storage apparatus (e.g., storage tank 110 in FIG. 1A). The heated salt 160 can be used in one application as input material to a heat exchange/power generation operation (not shown), for example, to supply electrical power to a power grid during peak usage time periods.

The illustrated system 200 and heat exchangers 300 advantageously provide efficient transfer of thermal energy to a transported salt material, in which the induction heating system is not in contact with, or otherwise immersed in the heated salt material. Thus, compared with conventional salt heating systems, the apparatus and techniques of the present disclosure advantageously avoid contact wear and/or erosion. Moreover, the induction heat transfer system can be operated using a programmable logic controller or other configurable control system (such to monitor and control the molten salt flow rate, power supply power level and resulting salt temperature).

Advantageously, the conductive tubes may be placed close together to increase efficiency. For example, placing the conductive tubes at a distance from each other of approximately 25% or less of conductive tube diameter may bring efficiency into the range of 90% or better. The conductive tubes may be made of a nonmagnetic material, which results in a more efficient heat transfer.

In this embodiment, none of the conductive tubes touch each other either directly or indirectly (e.g. through a metallic spacer) while under the presence of the induction field produced by the induction coil. The conductive tubes are separated by air, inert gas or dielectric. The conductive tubes may be identical. There may be end shortened Faraday copper rings provided at each end of the power coil. A Faraday ring is a shorted turn of copper or stainless steel. The induction field from the power coil produces a current in the Faraday ring but opposite in direction, and thus an electric field opposing that of the power coil. As a result, the field from the power coil cannot reach the outer bell ends of the heat exchanger and thus will not inductively heat them. As a result, energy is not wasted and electrical efficiency remains high.

The depth to which the current is produced in each tube is a function of the resistivity of the tube, its wall thickness, its permeability, and the frequency of the applied current. For example, the depth may be given by:

$${d}_{2} = 3.16 \sqrt{\frac{resistivity}{frequency * permiability}}$$

Resistivity is in micro-ohm in.

The objective in this case is choosing a tube material that is compatible with the caustic nature of the salt or salts. This objective could be met by choosing an Inconel base alloy or a 316 stainless. When a 316 stainless steel shell is selected, this eliminates the need for internal iron laminations. Thus, an embodiment comprises a 316 stainless steel shell with no internal iron laminations.

In addition, the tube wall thickness needs to be equal to or slightly less than the depth of current penetration. Doing this allows for as even as possible current distribution across the tube wall. If selected correctly, the entire wall of the tube will be heated by induction, and not just a thin outer layer. The purpose is to assure that benefits of inductive coupling directly coupling to tube is realized so that heat transfer is maximized to the flowing fluid. As a result, the time of heat transfer is minimized, making the entire system essentially directly responsive to a change to the power supply setting. Also, the gradient across the wall of the tube will be minimized so as to allow less thermal stress on the tube allowing the system to apply higher salt temperatures.

FIG. 4D shows cross sectional view 400d of an over heating of a tube exterior due to power supply frequency to high relative to wall thickness. For example, exterior portion 428 of tube 424 may be over heated relative to interior portion 432 of tube 424. FIG. 4E shows cross sectional view of when a depth of current penetration is equal to or slightly greater than a tube wall thickness. For example, the tube 424 is evenly heated because the depth of a current penetration equals or is slightly greater than tube wall thickness.

The efficiency of this induction tube induction is proportional to the ratio of the total area within all the tubes to the area within the induction coil. Thus, the greater the number of tubes within the coil the higher the electrical coupling efficiency.

Electrical coupling efficiency is proportional to:

$$\frac{( number of tubes ) ( area of each tube based on its O . D . )}{area within coil cross section}$$

This efficiency can range between 85% to 95%.

Electrical coupling efficiency would be maximized if the cross sectional area within the coil ID is equal to the area of the load, which would mean that the areas are equal. However, this is not possible because there is insulation and gaps between the tubes and the tubes cannot touch.

Generally, the induction coil ID is as close to the tube bundle OD while allowing some insulation on the coil ID to increase the thermal efficiencies while minimizing the ratio of the area inside the coil to the sum of all the areas within the tube ODs to as close to one as possible.

The thermal efficiencies depends on the insulation package used and is expected to be 90% to 95% or better.

The transmission line losses from the power supply to the induction coil range from 2 to 3.5%.

The power supply efficiencies range from 92% to 96%.

The above-discussed efficiencies will be application specific, but represent a reasonable range that can be expected.

A PLC (programmable logic controller) is included that integrates all diagnostics, menu driven operating screens for closed loop temperature control by varying kW to each reactor vessel. The system is also integrated into operations for safety interlocks and flow control.

In a preferred embodiment, low power is applied to the tubes to pre-heat the tubes to set point temperature. Valves open, and power level increases to high power to heat tubes to approximately 1150° F. Power level adjusts to maintain set point temperature through T/C set point closed loop control.

Elements that comprise the systems and methods described herein include the following.

Power leads/bus to convey current to the induction coil.

Power port for each vessel to allow the passage of power and water to the induction coil terminals while maintaining a air tight seal.

Controls that allow either the manual or automatic adjustment of signals (voltage, current, frequency and power) so as to control and provide the proper heating effect from the tubes to the flowing molten salt to raise the salt temperature to the desired process or set point temperature.

Thermocouples or optical pyrometers to measure the inlet molten salt temperature and the temperature of the salt as its temperature is being raised, thus providing the ability to monitor and provide manual or closed loop temperature control via a set point controller.

As a result, the flow rate of the incoming salt or its temperature may vary but the system will be able to adjust and still maintain the set point target temperature of the exiting molten salt.

Faraday rings to suppress the field produced by the induction power coil and thus inhibit the field from coupling to the bell ends and thus over heating them; thus the Farady increase the system efficiency.

All other coil insulation supports.

One of the main advantages of this system is that that at no time is any of the induction heating system submersed into or touching the molten salt. Thus, contact wear or erosion are not an issue. In other words, at no time are the heating elements in this the induction in contact with the salt so there is no corrosion or degradation to the induction coil and life is not affected.

Advantageously, the embodiments described herein provide the ability to accurately control the rate of rise of the salt (fluid) temperature within the tube bundle. Also advantageously, the embodiments described herein provide the ability to control the temperature of the tubes. Also advantageously, closed loop temperature control is possible by using thermocouples to sense the outlet temperature of the salt or tubes. Also advantageously, a customer can change the flow rate of the salt and the system will respond to accurately maintain the set point salt rise in temperature. Also advantageously, due to using solid state power supplies to provide kw/current/voltage control of power to the induction coil, the response time is much faster that other conventional means of heating liquid salt. Also advantageously, the various aspects of the design permit embodiments of the invention to be used in applications for heating other liquids as well.

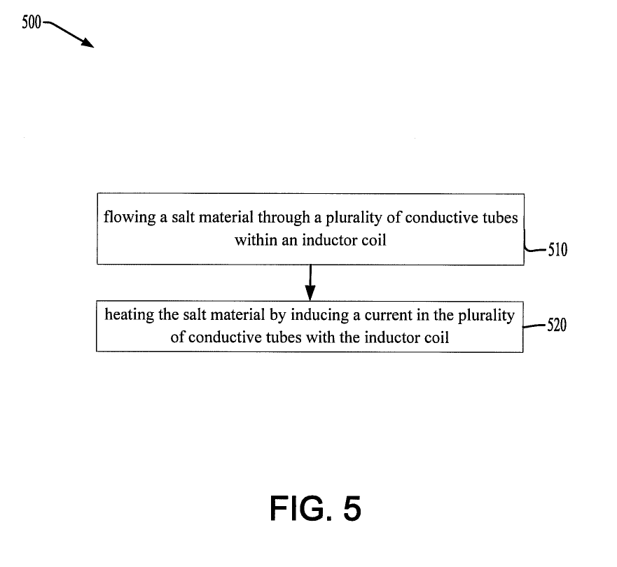

FIG. 5 illustrates heating a salt material. With reference thereto, process 500 may be implemented in heat exchanger 300. At 510, salt material is flowed through a plurality of conductive tubes within an induction coil. At 520, the salt material is heated by inducing a current in the plurality of conductive tubes with the inductor coil.

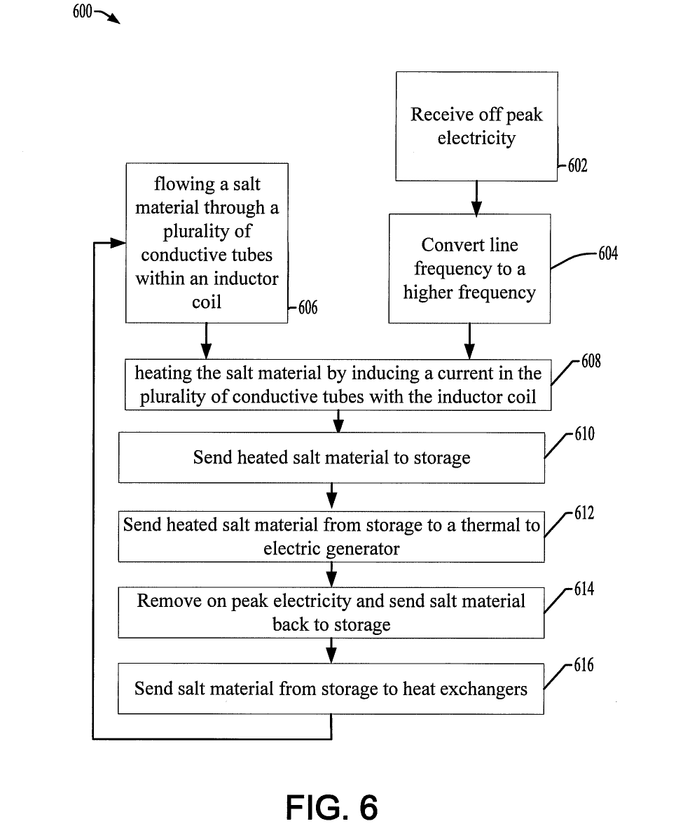

FIG. 6 illustrates heating a salt material. With reference thereto, at 602, off peak electricity is received. At 604, a line frequency is converted to a higher frequency. At 606, salt material is flowed through a plurality of conductive tubes within an induction coil. At 608, the salt material is heated by inducing a current in the plurality of conductive tubes with the inductor coil. At 610, the salt material is sent to storage. At 612, the heated salt material is sent from storage to a thermal to electric generator. At 614, on peak electricity is removed, and the salt material is sent back to storage. At 616, the salt material is sent from storage to the heat exchangers. Following that, the method may repeat by returning to 606.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, processor-executed software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several implementations, such feature may be combined with one or more other features of the other implementations as may be desired and advantageous for any given or particular application. Also, to the extent that the terms “including,” “includes,” “having,” “has,” “with,” or variants thereof are used in the detailed description and/or in the claims, such terms are intended to be inclusive in a manner similar to the term “comprising.”

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. In addition, the reference numerals in the drawings do not necessarily imply any specific order.

The following is claimed:

1. A heat transfer system, comprising:
a plurality of power supplies, each power supply of the plurality of power supplies configured to power a heat exchanger of a plurality of heat exchangers;
transfer pipes connecting the plurality of heat exchangers;
each heat exchanger of the plurality of heat exchangers comprising:
an enclosure defining an interior;
an induction coil within the interior; and
a plurality of conductive tubes within the induction coil for heating a salt material in the plurality of conductive tubes using a current induced by the induction coil.

2. The heat transfer system of claim 1, wherein each tube of the plurality of tubes is separated from other tubes of the plurality of tubes by air, inert gas, or dielectric.

3. The heat transfer system of claim 1, further comprising a bypass pipe connected to the transfer pipes at both:
a first point downstream to a first heat exchanger of the plurality of heat exchangers; and
a second point upstream to the first heat exchanger of the plurality of heat exchangers.

4. The heat transfer system of claim 1, wherein the plurality of heat exchangers are connected in series through the transfer pipes.

5. The heat transfer system of claim 1, wherein the plurality of heat exchangers are connected in parallel through the transfer pipes.

6. The heat transfer system of claim 1, wherein an internal pressure of the conductive tubes is less than an external pressure of the conductive tubes.

7. The heat transfer system of claim 1, wherein the plurality of heat exchangers are vertical.

8. The heat transfer system of claim 1, wherein the plurality of heat exchangers are horizontal.

9. The heat transfer system of claim 1, wherein the plurality of heat exchangers are generally horizontal, but have a slight downwards draft to facilitate draining of the salt material.

10. The heat transfer system of claim 1, wherein:
each tube of the plurality of tubes has a uniform tube diameter; and
tubes of the plurality of tubes are separated from each other by a distance of 25% of the tube diameter or less.

11. The heat transfer system of claim 1, wherein at least some of the plurality of conductive tubes are connected in series.

12. The heat transfer system of claim 1, wherein at least some of the plurality of conductive tubes are connected in parallel.

13. The heat transfer system of claim 1 further comprising a drain on an underside of the enclosure.

14. The heat transfer system of claim 1, wherein the individual heat exchangers include an inlet and an outlet, further comprising:
located at at least one inlet:
an inlet pressure sensor;
an inlet flow sensor; and
an inlet temperature sensor; and
located at at least one outlet:
an outlet pressure sensor;
an outlet flow sensor; and
and outlet temperature sensor.

15. A method for converting electrical energy to thermal energy for storage in a salt, comprising:
flowing a salt material through a plurality of conductive tubes within an inductor coil; and
heating the salt material by inducing a current in the plurality of conductive tubes with the inductor coil.

16. The method of claim 15, further comprising:
converting a grid current with a first frequency to an induction coil current with a second frequency;
wherein the second frequency is higher than the first frequency.

17. The method of claim 15, wherein a depth of a current penetration induced in a conductive tube of the plurality of tubes is equal to a wall thickness of the conductive tube of the plurality of tubes.

18. The method of claim 15, further comprising:
following a rupture in a conductive tube of the plurality of conductive tubes, draining the salt material from an enclosure surrounding the inductor coil.

19. A heat exchanger apparatus, comprising:
an enclosure defining an interior;
an induction coil within the interior; and
a plurality of conductive tubes within the induction coil for heating a salt material in the plurality of conductive tubes using a current induced by the induction coil.

20. The heat exchanger apparatus of claim 19, wherein each tube of the plurality of tubes is separated from other tubes of the plurality of tubes by air, inert gas, or dielectric.

21. The heat exchanger apparatus of claim 19, wherein an internal pressure of the conductive tubes is less than an external pressure of the conductive tubes.

22. The heat exchanger apparatus of claim 19, wherein:
each tube of the plurality of tubes has a uniform tube diameter; and
tubes of the plurality of tubes are separated from each other by a distance of 25% or less of the tube diameter.

23. The heat exchanger apparatus of claim 19, wherein at least some of the plurality of conductive tubes are connected in series.

24. The heat exchanger apparatus of claim 19, wherein at least some of the plurality of conductive tubes are connected in parallel.

25. The heat exchanger apparatus of claim 19, further comprising a drain on an underside of the enclosure.

26. The heat exchanger apparatus of claim 19, wherein the heat exchanger includes an inlet and an outlet, further comprising:
located at the inlet:
an inlet pressure sensor;
an inlet flow sensor; and
an inlet temperature sensor; and
located at the outlet:
an outlet pressure sensor;
an outlet flow sensor; and
and outlet temperature sensor.

27. The heat exchanger apparatus of claim 19, wherein the enclosure comprises a non-magnetic stainless steel shell configured to be water cooled; and
wherein the shell is at a distance from the induction coil that minimizes an inductive coupling from a field produced by the induction coil.

28. The heat exchanger apparatus of claim 19, wherein the enclosure comprises a carbon steel shell including a series of internal iron laminations to provide a low reluctance path for a field produced by the induction coil.

29. The heat exchanger apparatus of claim 19, wherein the enclosure comprises a 316 stainless steel shell.

30. The heat exchanger apparatus of claim 19, further comprising a humidity sensor system configured to generate an alert if a water leak develops from the induction coil.

31. A heat transfer system, comprising:
the heat exchanger apparatus of claim 19; and
a power supply providing power to the heat exchanger apparatus.

32. The heat transfer system of claim 31, wherein the power supply is a 1000 kilowatt power supply.
